(19) United States
(12) Patent Application Publication
(10) Pub. No.: US 2009/0158873 A1
(43) Pub. Date: Jun. 25, 2009

(54) Roller Screw with a Circulating Structure

(76) Inventors: Wen-Chia Wu, Taichung (TW); Jui-Long Hsu, Taichung (TW)

Correspondence Address: Dr. BANGER SHIA, 102 Lindencrest Ct., Sugar Land, TX, 77479-5201, US

(21) Appl. No.: 12/177,027

(22) Filed: Jul. 21, 2008

(30) Foreign Application Priority Data
Dec. 20, 2007 (TW) 096149010

(51) Int. Cl. F16H 55/02

(52) U.S. Cl. 74/424.86

(57) ABSTRACT

A roller screw with a circulating structure mainly comprises two circulating members and a return pipe. Each circulating member includes a return path that is rotated relative to a tangent plane tangent to the circumference of the helical groove of the nut, and the cross section of each return path is square-shaped. The return pipe is formed with a guiding route having a square-shaped cross section, and both ends of the guiding route are connected to the return paths of the circulating members, respectively. The return paths are connected to and tangent to the helical grooves, and an angle between the tangent surfaces is approximately 90 degrees. By such arrangements, the cross section of the roller screw with a circulating structure is continuous and complete, such that the rollers can be circulated in each path smoothly

### BACKGROUND OF THE INVENTION

1. Field of the Invention

The present invention relates to a roller screw with a circulating structure, and more particularly to a roller screw with a circulating structure which comprises a turning path that can prevent the deflection of the rollers during circulation and improve the circulation smoothness of the roller screw.

2. Description of the Prior Art

With the development of precision feeding systems, the technique and the products of roller screws are obviously important to the precision tool machines, and the products of different kinds of roller screws have already been used in human life, processing factories, and high-technical equipments. Though the roller screw technology has been growing rapidly, the products with rollers (such as a roller screw) still have some problems need to be solved, particularly in terms of size and smoothness of operation.

A conventional roller screw disclosed in U.S. Pat. No. 3,055,230 is shown in FIG. 7, to enable each roller 92 between a screw 90 and a nut 91 to circulate, a bent pipe 93 is designed to be the circulating system of the rollers 92. Since the bent pipe 93 has a rectangular-shaped cross section and must be processed to form a bending structure, such a bent pipe 93 is difficult to manufacture, it is not only laborsome and time consuming, but also high cost. In addition, the circulating system of the rollers 92 is overbending, and the quantity of the rollers 92 is too large, such that the rollers 92 cannot be circulated smoothly. And to cooperate with the rolling curve of the rollers 92, the return path must be disposed outside a nut 91, such that the volume of the nut 91 will be bigger. When the rollers 92 enter the circulating system from the nut 91, the rollers 92 will be firstly collided with the turning portion before entering the circulating system due to the design of the return path. Thereby, the path of the rollers 92 will not be in the form of a continuous curve, as a result, the rollers 10 cannot be circulated smoothly.

The present invention has arisen to mitigate and/or obviate the afore-described disadvantages.

### SUMMARY OF THE INVENTION

The primary objective of the present invention is to provide a roller screw with a circulating structure which can reduce the turning path of the roller during circulation and improve the circulation smoothness.

The second objective of the present invention is to provide a roller screw with a circulating structure which can reduce the size of the roller screw since the return path is disposed in the nut of the roller screw.

The third objective of the present invention is to provide a roller screw with a circulating structure which can reduce the problem of breaking off caused by the processing errors since the components of the circulating structure are made by molding process, and the entire return path is wrapped by multi-assembly methods.

The further objective of the present invention is to provide a roller screw with a circulating structure, one end of the return path of each roller is designed to be rotated relative to a tangent plane extending from a tangent direction of a helical groove of the screw, and the other end of the return path of each roller is designed to be rotated relative to a tangent plane extending from a tangent direction of a helical groove of the nut. And the rollers will circulate from the tangent plane of the other end of the return path into the corresponding helical groove of the screw again, such that the return path of the roller is in the form of a continuous curve, so as to prevent the rollers from being collided with the corresponding structures and to improve the circulation smoothness of the roller screw.

The roller screw with a circulating structure of the present invention comprises a screw, a nut, two circulating members, a return pipe and a plurality of column-shaped rollers.

The screw is formed with a helical groove. The nut is formed with a helical groove corresponding to the helical groove of the screw and is defined with a through hole. The plurality of rollers is disposed in the helical grooves of the screw and the nut, respectively. The return pipe is disposed in the though hole of the nut and is formed with a guiding route, having a square-shaped cross section. The circulating members are disposed in the grooves defined in the end surfaces of the nut, respectively. Each circulating member includes a return path that is tangent to and connected to the helical groove. The return paths are circulated from the tangent planes tangent to the helical grooves into the guiding route of the return pipe. An angle between each return path and the tangent plane tangent to the helical groove is approximately 90 degrees, thus keeping the smoothness of each path.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of a roller screw with a circulating structure in accordance with the present invention;

FIG. 2 is an exploded view of the roller screw with a circulating structure in accordance with the present invention;

FIG. 3 is an assembly perspective view showing circulating members being assembled with a return pipe;

FIG. 4 is a perspective view showing the path of each roller during circulation;

FIG. 5 is a partial cross sectional view showing the path of the rollers during circulation;

FIG. 6 is a cross sectional view showing the circulating members being connected to the return pipe; and

FIG. 7 is an illustrative view showing a conventional roller screw during circulation.

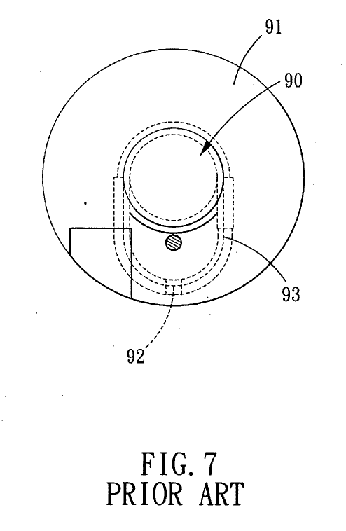

### DETAILED DESCRIPTION OF THE PREFERRED EMBODIMENTS

The present invention will be more clear from the following description when viewed together with the accompanying drawings, which show, for purpose of illustrations only, the preferred embodiment in accordance with the present invention.

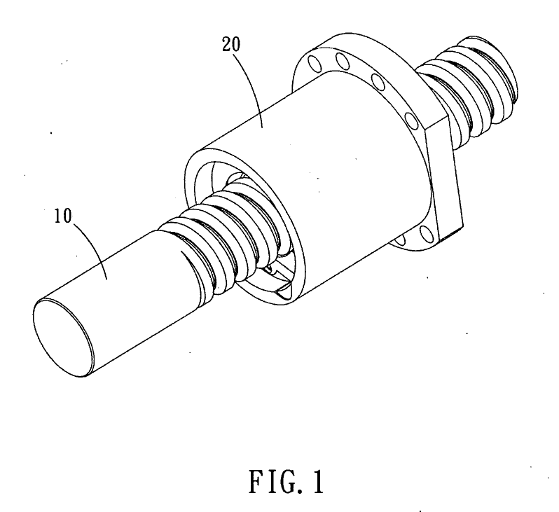

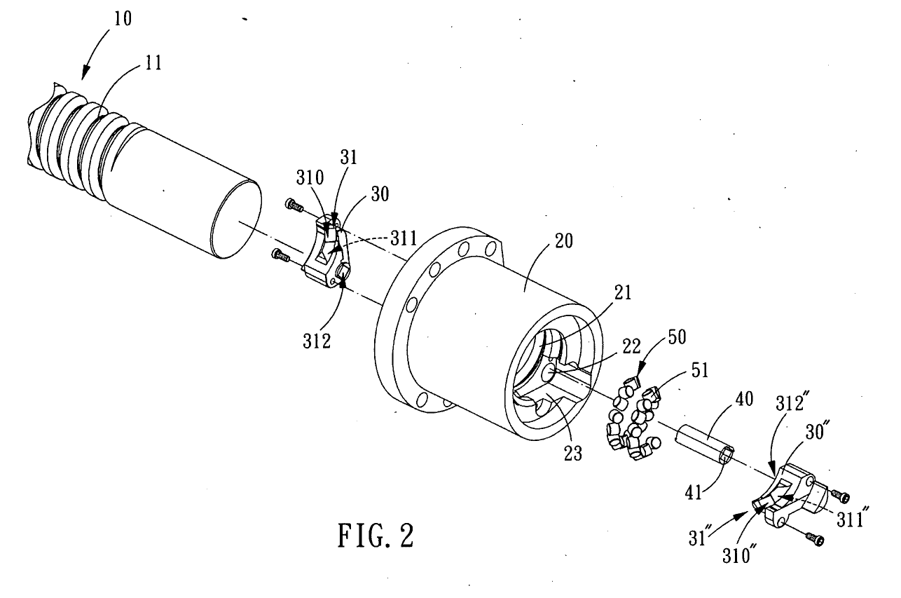

Referring to FIGS. 1-3, a roller screw with a circulating structure in accordance with the present invention comprises a screw 10, a nut 20, two L-shaped circulating members 30, 30″ disposed on both ends of the nut 20, a return pipe 40 disposed between the circulating members 30, 30″, and a plurality of column-shaped rollers 50.

The screw 10 is formed with a helical groove 11 having a V-shaped cross section.

The nut 20 is formed with a helical groove 21 corresponding to the helical groove 11 of the screw 10, and the cross section of the helical groove 21 is V-shaped. The nut 20 is defined with a through hole 22, and in both end surfaces of the nut 20 is formed a groove 23, respectively.

Both ends of each roller 50 are planes, and a periphery of each roller 50 is a rolling surface 51. The rollers 50 are disposed in the helical grooves 11, 21 of the screw 10 and the nut 20, respectively. The rolling surfaces 51 contact inner surfaces of the helical grooves 11, 21 of the screw 10 and the nut 20, respectively.

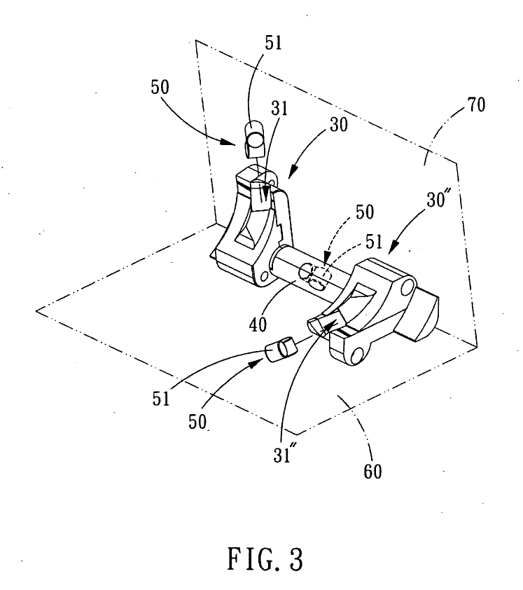

The circulating members 30, 30″ are disposed in the grooves 33 defined in the end surfaces of the nut 20, respectively. The circulating members 30, 30″ are disposed with return paths 31, 31″ that are mounted in a plane tangent to a circumference of the helical groove 21 of the nut 20, namely, as shown in FIG. 3, an angle between a tangent plane 60 where the inflow path (the path where the rollers 50 are entered) is located and a tangent plane 70 where the outflow path (the path where the rollers 50 are discharged) is located is approximately 90 degrees, and the tangent planes 60, 70 are formed at a jointing position between the helical grooves 11, 12 of the screw 10, the nut 20 and the return paths 31, 31″ of the circulating members 30, 30″.

The return paths 31, 31″ are tangent to the tangent planes 60, 70 extended from the helical grooves 11, 21, and straight tangent paths 310, 310″ are formed on the tangent planes 60, 70. The turning paths 311, 311″ that is turned 90 degrees are extended from the tangent paths 310, 310′, and short straight connecting paths 312, 312″ are extended from the ends of the turning paths 311, 311″ to the return pipe 40. The return paths 31 and 31″ are square-shaped in cross section so as to closely connect to the helical grooves 11, 21.

The return pipe 40 is cylinder-shaped and is disposed in the though hole 22 of the nut 20. A nonhelical guiding route 41 having a square-shaped cross section is formed in the return pipe 40. Both ends of the guiding route 41 are connected to the return paths 31, 31″ of the circulating members 30, 30″, respectively (as shown in FIG. 3). The cross sections of the return paths 31, 31″ connected to the helical grooves 11, 21 are equal in size to that of the return paths 31, 31″ connected to the guiding path 41.

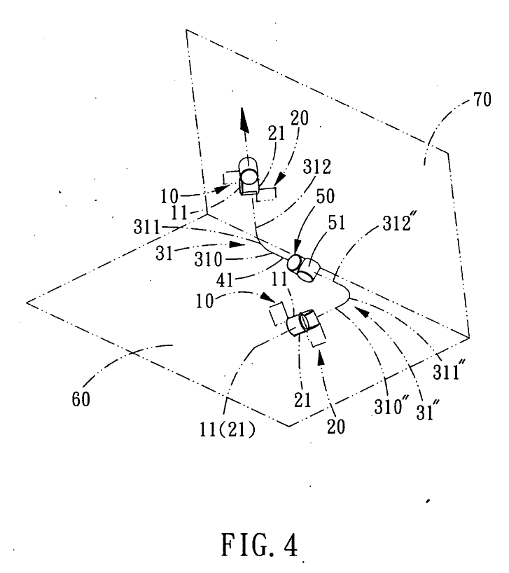

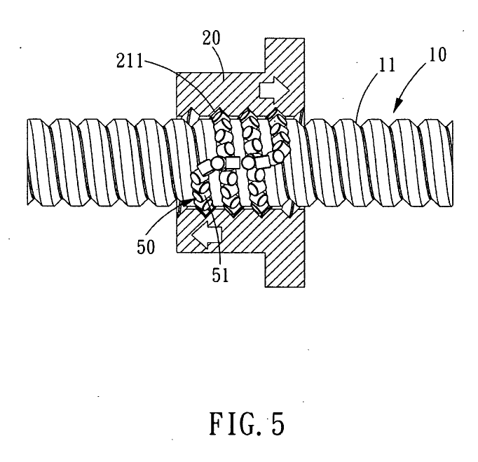

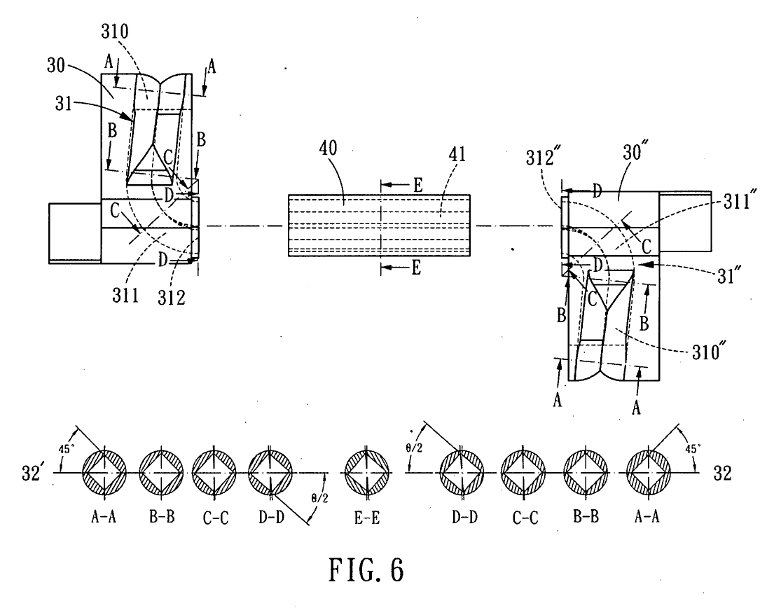

The circulation of the rollers 50 disposed in the helical grooves 11, 21 from the return paths 31, 31″ of the circulating members 30, 30″ into the guiding route 41 of the return pipe 40 is shown in FIGS. 4-6. The rollers 50 are staggeredly arranged and are column-shaped. The cross section of the roller 50 is equal in size to that of each path. Thereby, when circulating in each path, the staggeredly arranged rollers 50 can be maintained at 45 degrees relative to the tangent planes 60, 70, and with the design of the paths of the present invention, the rollers 50 can be prevented from deflecting during movement.

Referring to FIGS. 3-5, when circulating from the tangent plane 60 into the return path 31″ of the circulating member 30″ along the helical grooves 11, 21, and if the rolling surfaces 51 of the rollers 50 contact one side of the helical grooves 11, 21, the rollers 50 can enter the circulating member 30 almost without any deflection when entering the tangent path 310″ of the return path 31″ via the turning path 311″, and then circulating from the circulating member 30″ into the guiding route 41 of the return pipe 40 via the turning path 311″ and the connecting path 312″, since the cross section difference of the tangent path 310″, the return path 31″, the guiding route 41, the turning path 311″ and the connecting path 312″ is very small. After that, the rollers 50 enter the other circulating member 30, and reversely circulate from the connecting path 312 of the return path 31 of the circulating member 30 into the connecting paths 312″ via the turning path 311, and then circulate from the tangent plane 70 into the helical grooves 11, 21, such that the rollers 50 will be sent to the original path. At that time, the rolling surfaces 51 of the rollers 50 contact the other side of the helical grooves 11, 21, such that the rollers 50 circulate from the tangent plane 60 in the horizontal direction into the tangent plane 70 in the vertical direction, and then enter the helical grooves 11 and 21, thus achieving the return of the rollers 50 in such a manner that the rollers 50 are maintained at 90 degrees relative to the helical grooves 11, 21.

By such arrangements, the cross sections of the helical grooves 11, 21, the return paths 31, 31″ and the guiding route 41 will be in the form of a continuous curve, namely, the helical grooves 11, 21, the return paths 31, 31″ and the guiding route 41 are continuously and smoothly connected to form a smooth rolling path, such that the respective rollers 50 can be circulated smoothly.

To summarize, a roller screw with a circulating structure of the present invention not only can reduce the turning paths of the rollers during circulation, but also can reduce the size of the roller screw. In addition, the return paths of the rollers can be in the form of a continuous curve, so as to avoid the roller colliding with the turning portion, such that the rollers can be circulated smoothly.

While we have shown and described various embodiments in accordance with the present invention, it should be clear to those skilled in the art that further embodiments may be made without departing from the scope of the present invention.

What is claimed is:

1. A roller screw with a circulating structure, comprising:
a screw formed with a helical groove having a V-shaped cross section;
a nut formed with a helical groove corresponding to the helical groove of the screw and defined with a through hole;
a plurality of rollers orderly and staggeredly disposed in the helical grooves of the screw and the nut, each roller being formed with a rolling surface contacting one side of the helical groove of the screw or the nut
a return pipe disposed in the though hole of the nut and formed with a straight and nonhelical guiding route, having a square-shaped cross section; and
two circulating members disposed at both ends of the through hole of the nut, each circulating member including a return path, a cross section of each return path being equal in size to that of the helical grooves of the screw, the nut and the guiding route of the return pipe, each return path being formed with a turning path that is approximately turned 90 degrees, both ends of each return path being connected to the helical grooves of the screw, the nut and the guiding route of the return pipe;
wherein the rolling surface of each roller contacts and rolls on one side of the helical grooves of the screw and the nut first, after entering one of the circulating members, circulating from the guiding route of the return pipe into the other circulating member, and entering the helical grooves of the screw and nut, the rolling surface of each roller will contact and roll on the other side of the helical grooves of the screw and the nut.

2. The roller screw with a circulating structure as claimed in claim 1, wherein both end surfaces of the through hole of the nut are formed with a groove, respectively.

3. The roller screw with a circulating structure as claimed in claim 2, wherein the circulating members are disposed in the grooves of the nut.

4. The roller screw with a circulating structure as claimed in claim 1, wherein a tangent plane where an inflow path is located and a tangent plane where an outflow path is located are formed at a jointing position between the helical grooves of the screw, the nut and the return paths of the circulating members are formed with, and an angle between the tangent planes is approximately 90 degrees.

5. The roller screw with a circulating structure as claimed in claim 4, wherein the return paths of the circulating members are disposed on the tangent planes.

6. The roller screw with a circulating structure as claimed in claim 1, wherein the return paths of the circulating members are formed with straight tangent paths connecting to the helical grooves of the screw and the nut, at one end of each tangent path is formed a turning path that is turned 90 degrees, and a straight connecting path is formed between one end of each turning path and the guiding route of the return pipe.

7. The roller screw with a circulating structure as claimed in claim 1, wherein the rollers circulate from the helical grooves of the screw and the nut into the return path of one circulating member first, and then enter the guiding route of the return pipe, after circulating from the other circulating member into the helical grooves of the screw and the nut again, the rollers are maintain at 90 degrees relative to the helical grooves of the screw and the nut.
